(19) United States
(12) Patent Application Publication
(10) Pub. No.: US 2024/0312480 A1
(43) Pub. Date: Sep. 19, 2024

(54) DISK DEVICE

(71) Applicants: Kabushiki Kaisha Toshiba, Tokyo (JP); Toshiba Electronic Devices & Storage Corporation, Tokyo (JP)

(72) Inventor: Manabu UEHARA, Kawasaki Kanagawa (JP)

(21) Appl. No.: 18/461,961

(22) Filed: Sep. 6, 2023

(30) Foreign Application Priority Data
Mar. 15, 2023 (JP) 2023-040268

(51) Int. Cl. G11B 5/012; G11B 5/02; G11B 5/105; G11B 5/48

(52) U.S. Cl. CPC G11B 5/012; G11B 5/02; G11B 5/105; G11B 5/483; G11B 5/4833; G11B 5/4846

(57) ABSTRACT

According to one embodiment, a disk device includes a magnetic disk, a suspension, a magnetic head, and a carriage. The magnetic disk rotates about a first rotation axis. The suspension includes a base plate, a load beam, and a flexure. The magnetic head is attached to the flexure and configured to read and write information from and to the magnetic disk. The carriage includes an arm to which the base plate is attached. The carriage rotates about a second rotation axis to move the magnetic head with respect to the magnetic disk. The base plate includes a first surface and a second surface. The first surface faces the magnetic disk when the magnetic head is located on the magnetic disk. The second surface is opposite the first surface and faces the arm. A component different from the arm is disposed on the second surface.

### CROSS-REFERENCE TO RELATED APPLICATIONS

This application is based upon and claims the benefit of priority from Japanese Patent Application No. 2023-040268, filed on Mar. 15, 2023, the entire contents of which are incorporated herein by reference.

### FIELD

Embodiments described herein relate generally to a disk device.

### BACKGROUND

Disk devices such as a hard disk drive (HDD) typically include, for example, magnetic disks, suspensions, magnetic heads mounted on the respective suspensions, and a carriage that moves the suspensions. Each suspension includes a base plate attached to the carriage, a load beam attached to the base plate, and a flexure attached to the load beam.

Various kinds of components such as a load beam and a flexure are disposed on the surface of the base plate facing the magnetic disk. Thus, due to the proximity to the magnetic disk, such components may interfere with the magnetic disk.

### BRIEF DESCRIPTION OF THE DRAWINGS

FIG. 1 is an exemplary exploded perspective view illustrating an HDD according to a first embodiment;

FIG. 2 is an exemplary cross-sectional view illustrating a part of the HDD according to the first embodiment;

FIG. 3 is an exemplary plan view illustrating an HGA and an arm of the first embodiment;

FIG. 4 is an exemplary plan view illustrating the HGA and the arm of the first embodiment seen from the opposite side of FIG. 3;

FIG. 5 is an exemplary side view illustrating the magnetic disk, the HGA, and the arm of the first embodiment;

FIG. 6 is an exemplary plan view illustrating an HGA and an arm according to a second embodiment;

FIG. 7 is an exemplary plan view illustrating the HGA and the arm of the second embodiment seen from the opposite side of FIG. 6; and

FIG. 8 is an exemplary side view illustrating a magnetic disk, an HGA, and an arm of the second embodiment.

### DETAILED DESCRIPTION

In general, according to one embodiment, a disk device includes a magnetic disk, a suspension, a magnetic head, and a carriage. The magnetic disk is configured to rotate about a first rotation axis. The suspension includes a base plate, a load beam attached to the base plate, and a flexure attached to the load beam. The magnetic head is attached to the flexure and configured to read and write information from and to the magnetic disk. The carriage includes an arm to which the base plate is attached. The carriage is configured to rotate about a second rotation axis located apart from the first rotation axis to move the magnetic head with respect to the magnetic disk. The base plate includes a first surface and a second surface. The first surface is configured to face the magnetic disk when the magnetic head is located on the magnetic disk. The second surface is opposite the first surface and faces the arm. A component different from the arm is disposed on the second surface.

### First Embodiment

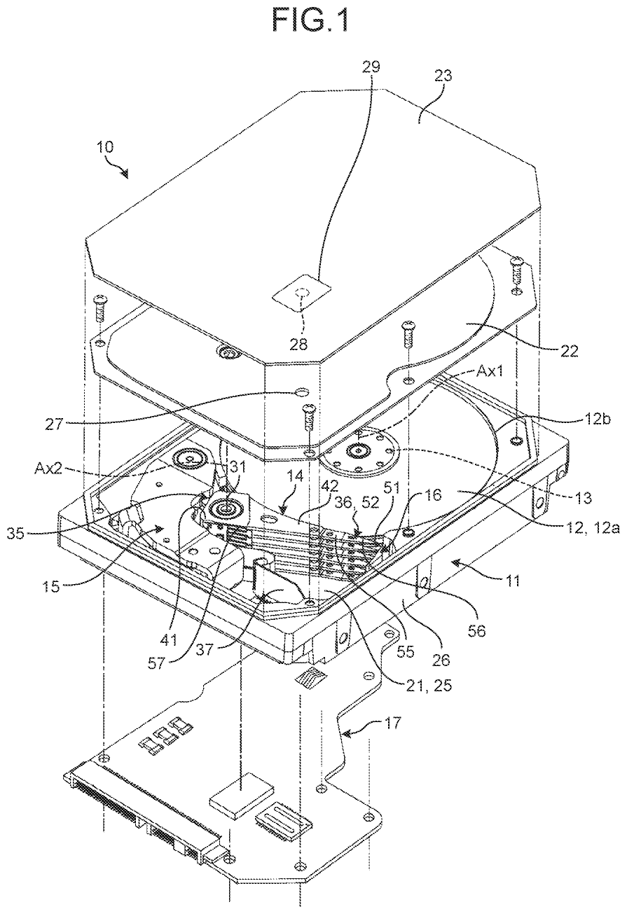

Hereinafter, a first embodiment will be described with reference to FIGS. 1 to 5. In the present specification, a plurality of expressions is used occasionally regarding components according to the embodiment and description on the components. The components and the description thereof are examples, and are not limited by the expressions in the present specification. Components can also be specified by different notations from those used in the present specification. Moreover, components can be described in terms that differ from the term used in the present specification.

FIG. 1 is an exemplary exploded perspective view illustrating a hard disk drive (HDD) 10 according to the first embodiment. The HDD 10 is an example of a disk device, and can also be referred to as an electronic device, a storage device, an external storage device, or a magnetic disk device. An example of the HDD 10 is a nearline (near-online) HDD. Note that the HDD 10 is not limited to this example.

As illustrated in FIG. 1, the HDD 10 includes a housing 11, a plurality of magnetic disks 12, a spindle motor 13, a head stack assembly (HSA) 14, a voice coil motor (VCM) 15, a ramp load mechanism 16, and a printed circuit board (PCB) 17. The magnetic disk 12 can also be referred to as a disk.

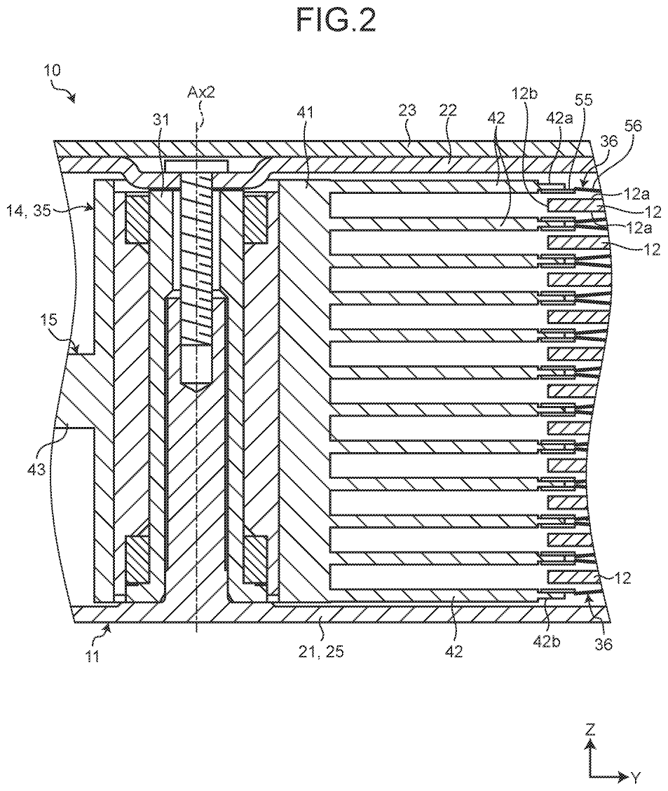

FIG. 2 is an exemplary cross-sectional view illustrating a part of the HDD 10 according to the first embodiment; As illustrated in FIG. 2, in the present specification, a Z axis and a Z direction are defined for convenience. The Z axis is provided along the thickness of the HDD 10. The Z direction is a direction along the Z axis and includes a +Z direction indicated by an arrow on the Z axis and a −Z direction being a direction opposite to the arrow on the Z axis.

The housing 11 includes a base 21, an inner cover 22, and an outer cover 23. Note that the housing 11 is not limited to this example. The base 21, the inner cover 22, and the outer cover 23 are each formed of a metal material such as an aluminum alloy. The base 21, the inner cover 22, and the outer cover 23 may be formed of mutually different materials.

As illustrated in FIG. 1, the base 21 has a substantially rectangular parallelepiped box shape opened in the +Z direction. The housing 11 houses the plurality of magnetic disks 12, the spindle motor 13, the HSA 14, the VCM 15, and the ramp load mechanism 16.

The base 21 has a bottom wall 25 and a side wall 26. The bottom wall 25 has a substantially rectangular (quadrangular) plate shape substantially orthogonal to the Z direction. The side wall 26 protrudes in the substantially +Z direction from the edge of the bottom wall 25 and has a substantially rectangular frame shape. The bottom wall 25 and the side wall 26 are integrally formed.

The inner cover 22 is attached to an end of the side wall 26 in the +Z direction with a screw, for example, so as to close the base 21. The outer cover 23 covers the inner cover 22 and is attached to the end of the side wall 26 in the +Z direction by welding, for example.

The inner cover 22 has a vent 27. Furthermore, the outer cover 23 has a vent 28. After the components are attached to the inside of the base 21, and the inner cover 22 and the outer cover 23 are attached to the base 21, the air inside the housing 11 is removed through the vents 27 and 28. Furthermore, the housing 11 is filled with a gas different from air.

Examples of the gas filled in the housing 11 include a low density gas having a density lower than that of air or an inert gas having low reactivity. For example, helium is filled inside the housing 11. The inside of the housing 11 may be filled with another fluid. The inside of the housing 11 may be maintained at vacuum, low pressure close to vacuum, or negative pressure lower than atmospheric pressure.

The vent 28 of the outer cover 23 is closed by a seal 29. The seal 29 hermetically seals the vent 28 and restricts the fluid filled inside the housing 11 from leaking through the vent 28 to the outside of the housing 11.

The plurality of magnetic disks 12 is situated orthogonal to the Z direction. The HDD 10 of the present embodiment is a device referred to as a 3.5 inch HDD. Therefore, the diameter of the magnetic disk 12 is 95 mm to 97 mm, for example. The thickness of the magnetic disk 12 in the Z direction is 0.3 mm or more and 0.5 mm or less. As illustrated in FIG. 2, the HDD 10 according to the present embodiment includes eleven magnetic disks 12, for example. Note that the dimensions and the number of the magnetic disks 12 are not limited to this example.

The plurality of magnetic disks 12 each has at least one recording surface 12a, for example. Each of the plurality of recording surfaces 12a is a surface of the magnetic disk 12 facing substantially the +Z direction or a surface of the magnetic disk 12 facing substantially the −Z direction. The recording surface 12a is a substantially flat surface orthogonal to the Z direction. The recording surface 12a is provided with a magnetic recording layer of the magnetic disk 12.

The plurality of magnetic disks 12 is stacked at intervals in the Z direction. The interval between the plurality of magnetic disks 12 is about 1.4 mm, for example. For example, a spacer is disposed between the plurality of magnetic disks 12.

The spindle motor 13 of FIG. 1 rotates the plurality of magnetic disks 12 around an axis Ax1 while supporting the magnetic disks 12. The axis Ax1, which is an example of a first rotation axis, is a virtual axis extending in the substantially Z direction. The axis Ax1 is the axis of the magnetic disk 12 and the spindle motor 13, for example. The plurality of magnetic disks 12 is held by a hub of the spindle motor 13 by a clamp spring, for example.

The housing 11 is provided with a support shaft 31 separated from the magnetic disk 12 in a direction orthogonal to the axis Ax1. The support shaft 31 extends in the substantially +Z direction from the bottom wall 25 of the housing 11, for example. The HSA 14 is rotatably supported by the support shaft 31.

The HSA 14 can rotate about an axis Ax2. The axis Ax2, which is an example of a second rotation axis, is a virtual axis extending in the substantially Z direction. The axis Ax2 matches the center of rotation of the HSA 14 and the axis of the support shaft 31, for example. Thus, the axis Ax2 is apart from the axis Ax1 in a direction orthogonal to the axis Ax1.

Hereinafter, an axial direction, a radial direction, and a circumferential direction are defined for convenience. The axial direction is a direction along the axis Ax2. The axial direction is equal to the Z direction. The radial direction is a direction orthogonal to the axis Ax2, and includes a plurality of directions orthogonal to the axis Ax2. The circumferential direction is a rotational direction around the axis Ax2, and includes clockwise and counterclockwise directions around the axis Ax2.

The HSA 14 includes a carriage 35, a plurality of head gimbal assemblies (HGA) 36, and a flexible printed circuit board (FPC) 37. As illustrated in FIG. 2, the carriage 35 includes an actuator block 41, a plurality of arms 42, and a coil holder 43.

The actuator block 41, the plurality of arms 42, and the coil holder 43 are integrally formed of aluminum, for example. Note that the materials of the actuator block 41, the arm 42, and the coil holder 43 are not limited to this example.

The actuator block 41 is supported by the support shaft 31 via a bearing so as to be rotatable about the axis Ax2, for example. This enables the carriage 35 to rotate about the axis Ax2.

The plurality of arms 42 protrudes in the radial direction from the actuator block 41. It is also allowable to have a configuration in which the HSA 14 is divided and the arm 42 protrudes from each of the plurality of actuator blocks 41.

In the present specification, an X axis and a Y axis are further defined for convenience. The X-axis, the Y-axis, and the Z-axis are orthogonal to each other. The Y axis is provided along the arm 42. Furthermore, in the present specification, an X direction and a Y direction are further defined. The X direction is a direction along the X axis, and includes a +X direction indicated by an arrow on the X axis and a −X direction being a direction opposite to the arrow on the X axis. The Y direction is a direction along the Y axis and includes a +Y direction indicated by an arrow on the Y axis and a −Y direction being a direction opposite to the arrow on the Y axis.

The plurality of arms 42 protrudes in the +Y direction from the actuator block 41. The Y direction thus corresponds to the longitudinal direction of the arm 42. The Y direction is included in the radial direction. The X direction corresponds to a lateral direction of the arm 42. The X direction and the Y direction change along with the rotation of the carriage 35 about the axis Ax2.

The plurality of arms 42 is disposed at intervals in the axial direction. Each of the arms 42 has a plate shape to enter a gap between the adjacent magnetic disks 12. The plurality of arms 42 extends substantially in parallel.

In the present embodiment, the carriage 35 includes twelve arms 42. The number of the arms 42 is larger by one than the number of the magnetic disks 12. Note that the number of the arms 42 is not limited to this example.

The coil holder 43 protrudes from the actuator block 41 in the −Y direction. The coil holder 43 holds a voice coil of the VCM 15. The VCM 15 includes the voice coil, a pair of yokes, and a magnet provided on the yoke.

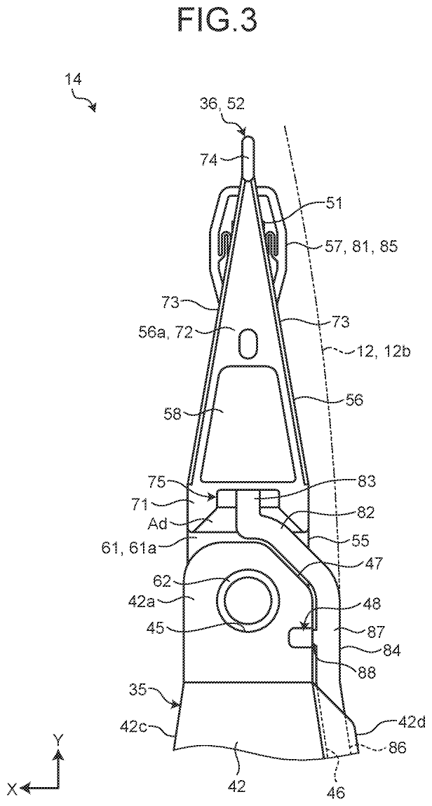

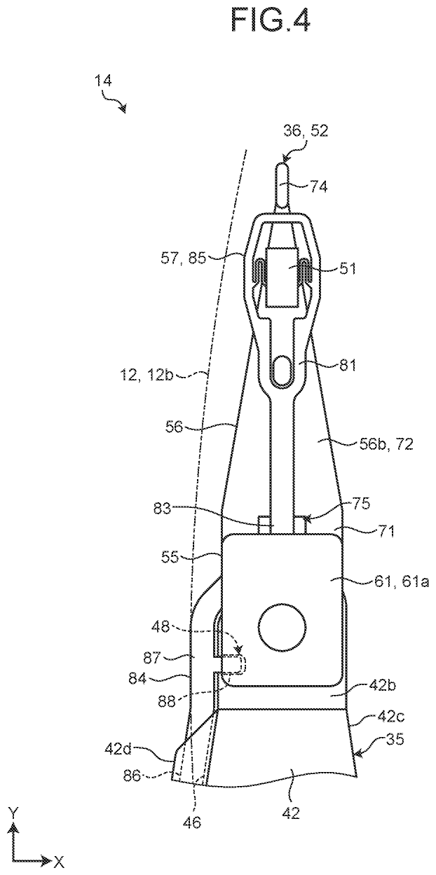

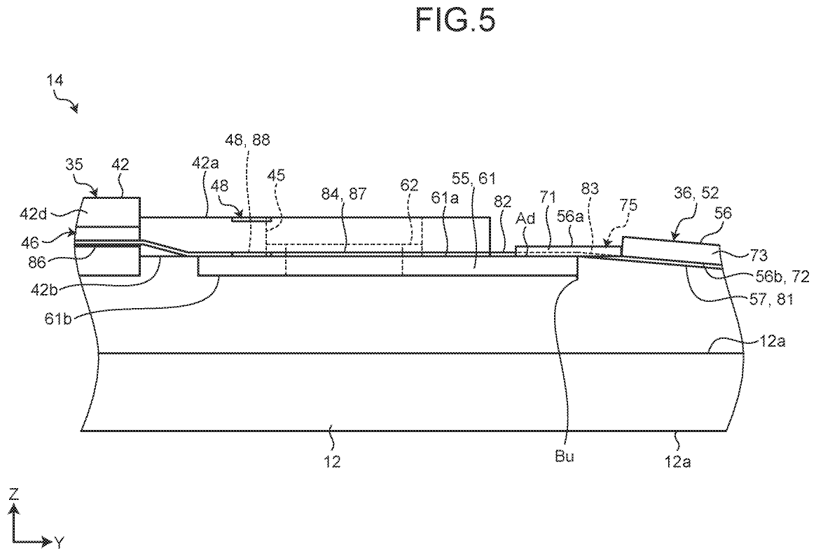

FIG. 3 is an exemplary plan view illustrating the HGA 36 and the arm 42 of the first embodiment. FIG. 4 is an exemplary plan view illustrating the HGA 36 and the arm 42 of the first embodiment seen from the opposite side of FIG. 3. FIG. 5 is an exemplary side view illustrating the magnetic disk 12, the HGA 36, and the arm 42 of the first embodiment.

As illustrated in FIG. 5, each of the plurality of arms 42 has two bearing surfaces 42a and 42b. The bearing surface 42a is an example of a sixth surface. The bearing surface 42b is an example of a fifth surface. The bearing surfaces 42a and 42b are located at the end of the arm 42 in the +Y direction. The bearing surface 42a is substantially flat and faces substantially the +Z direction. The bearing surface 42b is opposite the bearing surface 42a. The bearing surface 42b is substantially flat and faces substantially the −Z direction.

In the present embodiment, the maximum thickness of the arm 42 in the Z direction is about 0.7 mm, for example. The interval between the bearing surfaces 42a and 42b is about 0.47 mm, for example. Note that the dimensions of the arm 42 are not limited to this example.

As illustrated in FIG. 3, each of the plurality of arms 42 further includes an inner side surface 42c and an outer side surface 42d. The inner side surface 42c faces the approximately +X direction. The inner side surface 42c faces the axis Ax1. The outer side surface 42d is opposite the inner side surface 42c. The outer side surface 42d faces approximately the −X direction.

Each of the plurality of arms 42 is provided with a rivet hole 45, a slit 46, and a cutout 47. As illustrated in FIG. 5, each of the plurality of arms 42 is further provided with two recesses 48.

The rivet hole 45 is a circular hole that penetrates the arm 42 in the substantially Z direction and opens to the two bearing surfaces 42a and 42b. The slit 46 opens to the outer side surface 42d and extends approximately in the Y direction along the outer side surface 42d. In the Z direction (−Z direction), the slit 46 is located between the bearing surface 42a and the bearing surface 42b. The slit 46 is closer to the axis Ax2 than the rivet hole 45.

As illustrated in FIG. 3, the cutout 47 is provided at a corner between the end surface of the arm 42 in the +Y direction and the end surface of the arm 42 in the −X direction. Therefore, the bearing surfaces 42a and 42b are formed asymmetrically in the X direction. The bearing surfaces 42a and 42b may be formed line-symmetrically in the X direction.

One of the two recesses 48 opens to the bearing surface 42a and the end surface of the arm 42 in the −X direction. The other of the two recesses 48 opens to the bearing surface 42b and the end surface of the arm 42 in the −X direction.

Each of the plurality of HGA 36 is attached to either the bearing surface 42a or the bearing surface 42b of the arm 42 so as to protrude substantially in the +Y direction from the arm 42. With this configuration, the plurality of HGA 36 is arranged at intervals in the Z direction.

Hereinafter, the HGA 36 attached to the bearing surface 42b and the magnetic disk 12 corresponding to the HGA 36 will be mainly described. The HGA 36 attached to the bearing surface 42a is formed substantially mirror-symmetrical to the HGA 36 attached to the bearing surface 42b. In the following description of the HGA 36 attached to the bearing surface 42b, operations of replacing the +Z direction and the −Z direction with each other and replacing the bearing surface 42a and the bearing surface 42b with each other will enable understanding of the HGA 36 attached to the bearing surface 42a and the magnetic disk 12 corresponding to the HGA 36.

As illustrated in FIG. 4, each of the plurality of HGA 36 includes a magnetic head 51 and a suspension 52. The magnetic head 51 can also be referred to as a slider. The magnetic head 51 records and reproduces information on and from a corresponding one of the recording surfaces 12a of the plurality of magnetic disks 12. In other words, the magnetic head 51 reads and writes information from and to the magnetic disk 12.

The carriage 35 rotates about the axis Ax2 to move the magnetic head 51 with respect to the corresponding magnetic disk 12. The VCM 15 rotates the carriage 35 about the axis Ax2 to move the magnetic head 51 to a desired position along the recording surface 12a of the magnetic disk 12.

The magnetic head 51 moves to the outermost track of the magnetic disk 12 by the rotation of the HSA 14 driven by the VCM 15, and the ramp load mechanism 16 in FIG. 1 holds the magnetic head 51 away from the magnetic disk 12.

As illustrated in FIG. 5, the magnetic disk 12 corresponding to the magnetic head 51 of the HGA 36 is separated from the arm 42 in the −Z direction. When the magnetic head 51 is located on the recording surface 12a of the magnetic disk 12, the bearing surface 42b faces the corresponding magnetic disk 12.

As illustrated in FIG. 3, the suspension 52 is interposed between the arm 42 and the magnetic head 51. The suspension 52 includes a base plate 55, a load beam 56, a flexure 57, and a damper 58. The load beam 56 and the flexure 57 are examples of components.

The base plate 55 and the load beam 56 are formed of stainless steel, for example. The materials of the base plate 55 and the load beam 56 are not limited to this example. The base plate 55 and the load beam 56 may be formed of materials different from each other.

The base plate 55 includes a plate 61 and a boss 62. The plate 61 has a substantially quadrangular plate shape substantially orthogonal to the Z direction. As illustrated in FIG. 5, the plate 61 has an inner surface 61a and an outer surface 61b. The inner surface 61a is an example of a second surface. The outer surface 61b is an example of a first surface.

The inner surface 61a is substantially flat and faces substantially the +Z direction. The inner surface 61a and the bearing surface 42b of the arm 42 face each other and are in contact with each other. The outer surface 61b is opposite the inner surface 61a. The outer surface 61b is substantially flat and faces substantially the −Z direction. When the magnetic head 51 is located on the recording surface 12a of the magnetic disk 12, the outer surface 61b faces the corresponding magnetic disk 12.

The boss 62 protrudes from the inner surface 61a. The boss 62 has a substantially cylindrical shape to be fitted into the rivet hole 45 of the arm 42. By riveting the boss 62 to the arm 42, the base plate 55 is attached to the arm 42. The base plate 55 may be attached to the arm 42 by another method.

The load beam 56 has a plate shape thinner than the base plate 55. As illustrated in FIG. 3, the load beam 56 includes a base tab 71, a beam 72, two side rails 73, and a lift tab 74.

The base tab 71 is attached to the plate 61 with, for example, an adhesive element Ad away from the boss 62 in the +Y direction. Examples of the adhesive element Ad include a double-sided tape, an adhesive, or a viscoelastic material (VEM). As such, the load beam 56 is attached to the base plate 55. The base tab 71 may be attached to the plate 61 by other means such as spot welding.

In the present embodiment, the base tab 71 is attached to the inner surface 61a of the plate 61. Thus, the base tab 71 of the load beam 56 is placed on the inner surface 61a of the plate 61. Note that the components on the inner surface 61a are arranged not vertically above the inner surface 61a but in contact with the inner surface 61a or adjacent to the inner surface 61a with a gap. That is, the inner surface 61a faces the components while the components are disposed on the inner surface 61a.

The beam 72 extends approximately in the +Y direction from the end of the base tab 71 in the +Y direction. Specifically, as illustrated in FIG. 5, the beam 72 extends diagonally from the base tab 71 toward the corresponding magnetic disk 12. That is, the beam 72 extends from the base tab 71 in a diagonal direction between the +Y direction and the −Z direction.

The load beam 56 further includes an inner surface 56a and an outer surface 56b. The inner surface 56a is an example of a fourth surface. The outer surface 56b is an example of a third surface. The inner surface 56a and the outer surface 56b are the surface of the load beam 56 located on the base tab 71 and the beam 72.

The inner surface 56a faces approximately the +Z direction. The outer surface 56b is opposite the inner surface 56a and faces approximately the −Z direction. The outer surface 56b of the base tab 71 is in contact with the inner surface 61a of the plate 61. When the magnetic head 51 is located on the recording surface 12a of the magnetic disk 12, the outer surface 56b faces the corresponding magnetic disk 12.

As illustrated in FIG. 3, the base tab 71 is provided with a cutout 75. The cutout 75 is an example of a hole. The cutout 75 penetrates the base tab 71 in substantially the Z direction and opens to the inner surface 56a, the outer surface 56b, and an end of the base tab 71 in the −Y direction.

In the +Y direction, the end of the cutout 75 is spaced from the end of the plate 61. The cutout 75 thus form a hole penetrating the suspension 52 in substantially the Z direction.

The cutout 75 divides at least a portion of the base tab 71 to be attached to the plate 61. The presence of the cutout 75 lowers the rigidity of the portion of the base tab 71 attached to the plate 61 and increases the likelihood of occurrence of elastic deformation of the load beam 56. That is, the cutout 75 adjusts the rigidity of the load beam 56.

The two side rails 73 protrude approximately in the Z direction from both ends of the beam 72 in the X direction. In other words, the two side rails 73 protrude from the inner surface 56a of the beam 72. The two side rails 73 extend approximately in the Y direction along both ends of the beam 72 in the X direction.

The lift tab 74 is provided at the end of the beam 72 in the +Y direction. When the ramp load mechanism 16 holds the magnetic head 51, the lift tab 74 is supported by the ramp load mechanism 16.

The flexure 57 has an elongated strip shape. The flexure 57 is a flexible substrate including a metal plate (backing layer) formed of stainless steel or the like, an insulating layer (base layer) formed on the metal plate, a conductive layer formed on the insulating layer and constituting a plurality of wiring lines (wiring patterns), and an insulating protective layer (cover layer) covering the conductive layer, for example. The flexure 57 is not limited to this example.

The flexure 57 includes a first part 81, a second part 82, a third part 83, and a fourth part 84. The fourth part 84 can also be referred to as a suspension tail. Each of the first part 81, the second part 82, the third part 83, and the fourth part 84 constitutes a part of the flexure 57, and includes at least one of a metal plate, an insulating layer, a conductive layer, or a protective layer.

As illustrated in FIG. 4, the first part 81 is attached to the outer surface 56b of the beam 72 by spot welding, for example. That is, the first part 81 is disposed on the outer surface 56b. The first part 81 includes a gimbal 85.

The gimbal 85 is located at an end of the flexure 57 in the +Y direction. The magnetic head 51 is mounted on the gimbal 85. In this manner, the magnetic head 51 is attached to the flexure 57 and electrically connected to the flexure 57.

The gimbal 85 includes, for example, a frame-shaped part attached to the beam 72 and an elastically displaceable part with respect to the frame-shaped part. The magnetic head 51 is mounted on the elastically displaceable part. The gimbal 85 is not limited to this example.

As illustrated in FIG. 3, the second part 82 is disposed on the inner surface 61a of the plate 61. The second part 82 is attached to the inner surface 61a with the adhesive element Ad or by spot welding, for example. The second part 82 may not be attached to the inner surface 61a.

The second part 82 is disposed on the inner surface 61a of the plate 61. That is, in the present embodiment, the load beam 56 and the flexure 57 are disposed on the inner surface 61a. Either one of the load beam 56 or the flexure 57 may be disposed on the outer surface 61b of the plate 61.

The third part 83 extends between an end of the first part 81 in the −Y direction and an end of the second part 82 in the +Y direction through the cutout 75. The third part 83 may extend diagonally with respect to the inner surface 61a of the plate 61, or may be bent at a plurality of positions.

The adhesive element Ad is located between the second part 82 and the plate 61 at the periphery of the boundary between the second part 82 and the third part 83. With this configuration, the adhesive element Ad suppresses the plate 61 from damaging the flexure 57.

The adhesive element Ad increases the thickness of the HGA 36. However, since the adhesive element Ad increases the thickness of the HGA 36 in the +Z direction, it is possible to suppress the load beam 56 from approaching the magnetic disk 12.

The second part 82 extends from the third part 83 along the cutout 47 of the arm 42 in approximately the −X direction. That is, the cutout 47 is formed in the arm 42 so as to avoid the flexure 57. Note that the cutout 47 is not limited to this example.

The fourth part 84 extends from the second part 82 toward the actuator block 41. An end of the fourth part 84 is connected to one end of the FPC 37 attached to the actuator block 41. The other end of the FPC 37 is connected to a connector mounted on the bottom wall 25, for example.

As illustrated in FIG. 4, the fourth part 84 includes an inner extension 86, an outer extension 87, and a tab 88. The outer extension 87 is an example of a part of the fourth part. The tab 88 is an example of an attachment part. The inner extension 86 is accommodated in the slit 46. The outer extension 87 is located between the second part 82 and the inner extension 86. In other words, the outer extension 87 is located between the second part 82 and the slit 46. The outer extension 87 is located outside the slit 46 further away from the axis Ax1 than the base plate 55.

As illustrated in FIG. 5, the outer extension 87 is located further away from the corresponding magnetic disk 12 than the base plate 55 in the Z direction. Furthermore, the outer extension 87 is closer to the slit 46 than the outer surface 61b of the plate 61 in the Z direction.

As illustrated in FIG. 4, the tab 88 extends from the outer extension 87 in approximately the +X direction. A part of the tab 88 is housed in the recess 48 of the arm 42. Inside the recess 48, the tab 88 is attached to the arm 42 by spot welding, for example.

The thickness of the tab 88 in the Z direction is smaller than the depth of the recess 48 in the Z direction. With this dimensions, the tab 88 is separated apart from the plate 61. The tab 88 may be in contact with the plate 61 or may be attached to the plate 61.

In the present embodiment, the thickness of the plate 61 is about 0.1 mm, for example. The thickness of each of the base tab 71 and the beam 72 is about 0.03 mm, for example. The flexure 57 has a thickness of about 0.04 mm, for example. Each dimension of the HGA 36 is not limited to this example.

As illustrated in FIG. 3, the damper 58 is attached to the inner surface 56a of the beam 72. The damper 58 includes: a restraint plate formed of stainless steel, aluminum, or synthetic resin; and a VEM that sticks the restraint plate to the beam 72, for example. The displacement of the restraint plate ease the vibration of the load beam 56.

Examples of the PCB 17 in FIG. 1 include a rigid substrate such as a glass epoxy substrate, including a multilayer substrate, a build-up substrate, or the like. The PCB 17 is disposed outside the housing 11 and attached to the bottom wall 25.

The PCB 17 includes various electronic components such as a relay connector connected to the FPC 37, an interface (I/F) connector connected to the host computer, and a controller that controls the operation of the HDD 10. The relay connector is electrically connected to the FPC 37 via a connector provided on the bottom wall 25.

For example, the controller of the PCB 17 drives the VCM 15 to rotate the HSA 14 about the axis Ax2. With this operation, the controller controls the position of the magnetic head 51. The controller may use a microactuator provided in the gimbal 85 to adjust the position of the magnetic head 51, for example.

For example, the magnetic disk 12 vibrates in some cases. In this case, the amplitude of the magnetic disk 12 is the largest at the outer edge 12b of the magnetic disk 12. That is, the outer edge 12b of the magnetic disk 12 sometimes vibrates so as to approach the HGA 36.

When the HGA 36 is located in the vicinity of the outer edge 12b of the magnetic disk 12 indicated by a two-dot chain line in FIGS. 3 and 4, the outer extension 87 of the flexure 57 comes close to the outer edge 12b of the magnetic disk 12. At this time, when the magnetic disk 12 vibrates, the outer edge 12b of the magnetic disk 12 approaches the outer extension 87.

In the present embodiment, the second part 82 of the flexure 57 is disposed on the inner surface 61a of the plate 61. That is, the second part 82 and the fourth part 84 of the flexure 57 are more separated from the magnetic disk 12 than from the plate 61. Therefore, the outer edge 12b of the vibrating magnetic disk 12 is less likely to come into contact with the flexure 57.

Furthermore, the base tab 71 of the load beam 56 is positioned on the inner surface 61a of the plate 61. That is, the base tab 71 is farther from the magnetic disk 12 than from the plate 61. Therefore, the vibrating magnetic disk 12 is less likely to come into contact with the base tab 71.

The base plate 55 is formed by punching, for example. As illustrated in FIG. 5, the punching might produce burrs Bu in the plate 61. The base plate 55 is processed to generate the burrs Bu on the outer surface 61b of the plate 61. Therefore, the base plate 55 can suppress a situation in which the burrs Bu damage the flexure 57 disposed on the inner surface 61a.

Before the load beam 56 is attached to the base plate 55, the flexure 57 is attached to the load beam 56. Therefore, the flexure 57 can be easily passed through the cutout 75.

In the HDD 10 according to the first embodiment described above, the base plate 55 includes the outer surface 61b configured to face the magnetic disk 12 when the magnetic head 51 is located on the magnetic disk 12; and the inner surface 61a opposite the outer surface 61b and facing the arm 42. A component different from the arm 42 is disposed on the inner surface 61a. Due to such arrangement, the HDD 10 allows a longer distance between the component and the magnetic disk 12 than the distance between the component disposed on the outer surface 61b and the magnetic disk 12. As such, the HDD 10 can include a larger number of magnetic disks 12 while reducing or preventing occurrence of interference between the components and the magnetic disks 12.

The component disposed on the inner surface 61a includes at least either of the load beam 56 and the flexure 57. Thereby, the HDD 10 allows a longer distance between the suspension 52 and the magnetic disk 12, leading to reducing or preventing occurrence of interference between the suspension 52 and the magnetic disk 12.

The component disposed on the inner surface 61a includes the flexure 57. Typically, a part (fourth part 84) of the flexure 57 is more spaced from the axis Ax1 of the magnetic disk 12 than the base plate 55. Because of this, when the magnetic disk 12 vibrates, the flexure 57 is more likely to interfere with the outer edge 12b of the magnetic disk 12 than the base plate 55. According to the present embodiment, however, at least a part of the flexure 57 is located on the inner surface 61a of the base plate 55. With this configuration, the HDD 10 allows a longer distance between the flexure 57 and the magnetic disk 12, leading to reducing or preventing occurrence of interference between the flexure 57 and the magnetic disk 12.

The load beam 56 includes the outer surface 56b configured to face the magnetic disk 12 when the magnetic head 51 is located on the magnetic disk 12; and the inner surface 56a opposite the outer surface 56b. The load beam 56 is provided with the cutout 75 that opens to the outer surface 56b and the inner surface 56a. The flexure 57 includes the first part 81 attached to the outer surface 56b and on which the magnetic head 51 is mounted; the second part 82 disposed on the inner surface 61a; and the third part 83 extending between the first part 81 and the second part 82 through the cutout 75. That is, the flexure 57 can be disposed on the inner surface 61a through the cutout 75 for adjusting the rigidity of the load beam 56. As such, the suspension 52 can be avoided from having a complex structure.

The arm 42 has the bearing surface 42b facing the inner surface 61a and the bearing surface 42a opposite the bearing surface 42b. The arm 42 is provided with the slit 46 between the bearing surface 42b and the bearing surface 42a in the Z direction which the bearing surface 42b faces. The flexure 57 includes the fourth part 84 extending from the second part 82 to be accommodated in the slit 46. As described above, the second part 82 of the flexure 57 is disposed on the inner surface 61a. This results in a shorter distance between the second part 82 and the slit 46 than that between the second part 82 located on the outer surface 61b and the slit 46. This allows an easier insertion of the fourth part 84 extending from the second part 82 into the slit 46, facilitating the assembly of the suspension 52 in the HDD 10. Furthermore, the HDD 10 can reduce the slack of the fourth part 84, leading to avoiding displacement between the pad on the flexure 57 and the pad on the FPC 37.

The outer extension 87 as a part of the fourth part 84 is located outside the slit 46 between the second part 82 and the slit 46. The outer extension 87 is more spaced from the axis Ax1 than the base plate 55 and more spaced from the magnetic disk 12 than the base plate 55 in the Z direction that the bearing surface 42b faces. Thereby, the outer extension 87 can be prevented from interfering with the magnetic disk 12 in spite of its closeness to the outer edge 12b of the magnetic disk 12 having a high amplitude.

The arm 42 is provided with the recess 48 opening to the bearing surface 42b. The flexure 57 includes a tab 88 accommodated in the recess 48 and attached to the arm 42. As such, according to the HDD 10, despite the location of the second part 82 on the inner surface 61a, the flexure 57 is less likely to partially intervene between the inner surface 61a of the base plate 55 and the bearing surface 42b of the arm 42 to cause a gap. In addition, the base plate 55 typically has a thinner thickness than the arm 42, therefore, it is easier to form the recess 48 in the arm 42 than in the base plate 55.

The component disposed on the inner surface 61a includes the load beam 56. Thus, both the load beam 56 and the flexure 57 are disposed on the inner surface 61a. With this configuration, the HDD 10 enables a longer distance between the suspension 52 and the magnetic disk 12, reducing or preventing occurrence of interference between the suspension 52 and the magnetic disk 12.

The number of the magnetic disks 12 mounted on the HDD 10 is eleven or more. In general, as the number of magnetic disks 12 increases, the distance between the suspension 52 and the magnetic disk 12 decreases. However, the HDD 10 of the present embodiment including a large number of magnetic disks 12 can still reduce or prevent occurrence of interference between the components arranged on the inner surface 61a and the magnetic disks 12, as described above.

### Second Embodiment

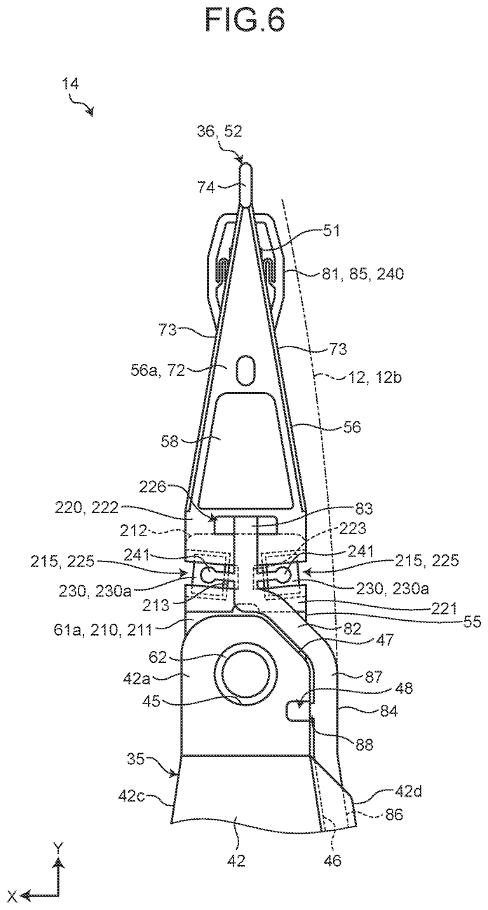

Hereinafter, a second embodiment will be described with reference to FIGS. 6 to 8. Note that in the following embodiment, for components with functions similar to the functions of the already-described components, a same sign as of the already-described components will be given and description for these will be omitted in some cases. A plurality of components with a same sign does not always have a same function or property but may have a different function and property according to each of the embodiments.

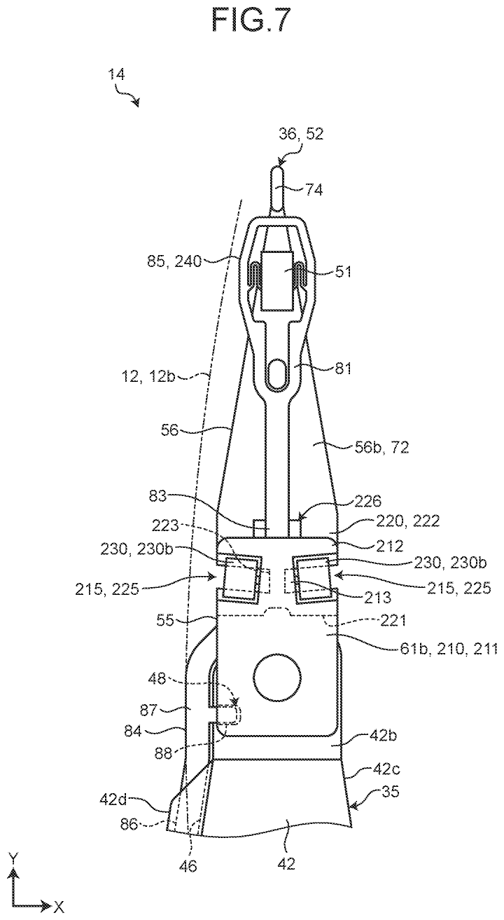

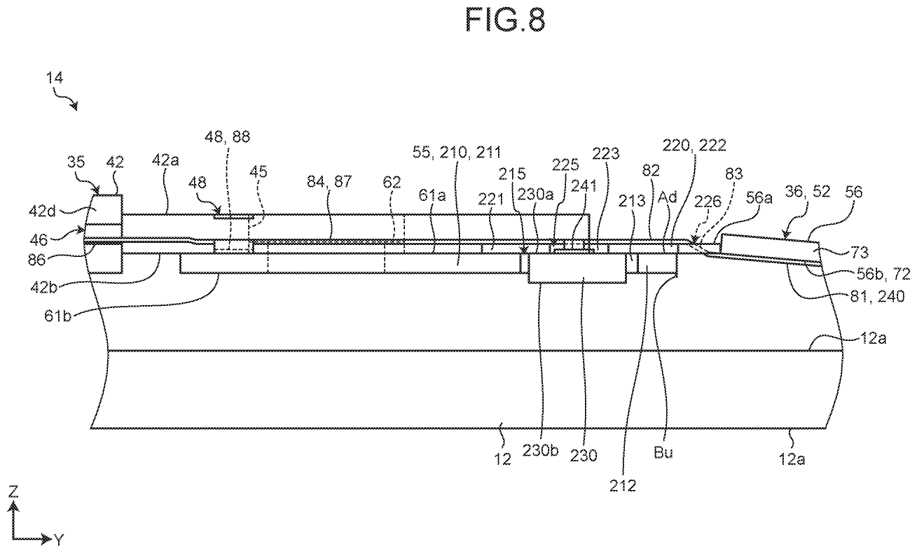

FIG. 6 is an exemplary plan view illustrating HGA 36 and the arm 42 according to the second embodiment. FIG. 7 is an exemplary plan view illustrating the HGA 36 and the arm 42 of the second embodiment seen from the opposite side of FIG. 6. FIG. 8 is an exemplary side view illustrating the magnetic disk 12, the HGA 36, and the arm 42 of the second embodiment.

As illustrated in FIG. 7, the base plate 55 of the second embodiment includes a plate 210 instead of the plate 61. The plate 210 is substantially equal to the plate 61 except for the following.

The plate 210 has a rear part 211, a front part 212, and an intermediate part 213. Each of the rear part 211, the front part 212, and the intermediate part 213 is part of the plate 210 and includes part of the inner surface 61a and the outer surface 61b.

The rear part 211 is attached to the arm 42. That is, the boss 62 protrudes from the inner surface 61a of the rear part 211. The inner surface 61a of the rear part 211 and the bearing surface 42b of the arm 42 face each other.

The front part 212 is separated from the rear part 211 in the +Y direction. The intermediate part 213 connects an end of the rear part 211 in the +Y direction and an end of the front part 212 in the −Y direction to each other. In the X direction, the width of the intermediate part 213 is shorter than the width of the rear part 211 and is shorter than the width of the front part 212. The intermediate part 213 connects substantially the center of the rear part 211 in the X direction and substantially the center of the front part 212 in the X direction to each other. This allows the front part 212 and the intermediate part 213 to be formed in a substantially T shape.

In other words, the plate 210 has two cutouts 215. The two cutouts 215 penetrate the plate 210 in the substantially Z direction so as to open to the inner surface 61a and the outer surface 61b of the plate 210. One notch 215 is open to the end of the plate 210 in the +X direction. The other notch 215 opens to the end of the plate 210 in the −X direction.

In the X direction, the intermediate part 213 is located between the two cutouts 215. The two cutouts 215 separate the rear part 211 and the front part 212 from each other. With the presence of the two cutouts 215, the substantially T-shaped front part 212 and the intermediate part 213 are formed in the plate 210.

As illustrated in FIG. 6, the load beam 56 of the second embodiment includes a base tab 220 instead of the base tab 71. Base tab 220 is substantially equal to base tab 71 except for the following.

The base tab 220 has a rear part 221, a front part 222, and an intermediate part 223. Each of the rear part 221, the front part 222, and the intermediate part 223 is part of the base tab 220 and includes part of the inner surface 56a and the outer surface 56b.

The front part 222 is connected to the beam 72. The rear part 221 is separated from the front part 222 in the −Y direction. The intermediate part 223 connects an end of the rear part 221 in the +Y direction and an end of the front part 222 in the −Y direction to each other.

In the X direction, the width of the intermediate part 223 is shorter than the width of the rear part 221 and is shorter than the width of the front part 222. The intermediate part 223 connects substantially the center of the rear part 221 in the X direction and substantially the center of the front part 222 in the X direction to each other. This allows the rear part 221 and the intermediate part 223 to be formed in a substantially T shape.

In other words, the base tab 220 is provided with two cutouts 225. The two cutouts 225 penetrate the base tab 220 in the substantially Z direction so as to open to the inner surface 56a and the outer surface 56b of the base tab 220. One of the cutouts 225 opens to the end of the base tab 220 in the +X direction. The other notch 225 opens to an end of the base tab 220 in the −X direction.

Each of the two cutouts 225 communicates with the notch 215 of the corresponding plate 210. In the Y direction, the length of the notch 215 of the plate 210 is greater than the length of the notch 225 of the base tab 220.

In the X direction, the intermediate part 223 is located between the two cutouts 225. The two cutouts 225 separate the rear part 221 and the front part 222 from each other. With the presence of the two cutouts 225, the substantially T-shaped rear part 221 and the intermediate part 223 are formed in the base tab 220.

The base tab 220 of the second embodiment is provided with a hole 226 instead of the notch 75. The hole 226 penetrates the front part 222 in the substantially Z direction so as to open to the inner surface 56a and the outer surface 56b of the front part 222.

At least a part of the hole 226 is separated in the +Y direction from the end of the plate 210 in the +Y direction. The hole 226 reduces the rigidity of the base tab 220 and adjusts the rigidity of the load beam 56.

The HGA 36 of the second embodiment further includes two piezoelectric elements 230. The piezoelectric element 230 can also be referred to as an actuator. The piezoelectric element 230 is a bulk piezoelectric element, for example. The piezoelectric element 230 may be a bulk multilayer piezoelectric element or thin film piezoelectric element.

As illustrated in FIG. 8, each of the two piezoelectric elements 230 is housed in a corresponding one of the two cutouts 215 of the plate 210. An end part of the piezoelectric element 230 in the +Y direction is attached to the front part 222 of the base tab 220 by using an adhesive, for example. An end part of the piezoelectric element 230 in the −Y direction is attached to the rear part 221 of the base tab 220 by using an adhesive, for example. In this manner, the piezoelectric element 230 is attached to the load beam 56.

The piezoelectric element 230 may be attached to the base plate 55. For example, the end of the piezoelectric element 230 in the +Y direction may be attached to the front part 212 of the plate 210, while the end of the piezoelectric element 230 in the −Y direction may be attached to the rear part 211 of the plate 210.

The piezoelectric element 230 has a rectangular parallelepiped shape, for example. The piezoelectric element 230 has an inner surface 230a and an outer surface 230b. The inner surface 230a is an example of an eighth surface. The outer surface 230b is an example of a seventh surface.

The inner surface 230a faces substantially the +Z direction. The inner surface 230a of the piezoelectric element 230 and the outer surface 56b of the base tab 220 face each other. The piezoelectric element 230 includes an electrode on the inner surface 230a. The outer surface 230b is opposite the inner surface 230a. When the magnetic head 51 is located on the magnetic disk 12, the outer surface 230b faces the magnetic disk 12.

The HGA 36 of the second embodiment includes a flexure 240 instead of the flexure 57. The flexure 240 is substantially identical to the flexure 57 except for the following. As illustrated in FIG. 6, a part of the second part 82 of the flexure 240 is located between the two piezoelectric elements 230 in the X direction.

The flexure 240 includes two connection tabs 241. The two connection tabs 241 extend in substantially the X direction from the second part 82. Each of the two connection tabs 241 is connected to the inner surface 230a of the corresponding piezoelectric element 230 by using a conductive adhesive or solder, for example. In this manner, the flexure 240 is electrically connected to the piezoelectric element 230. The connection tab 241 is disposed on the inner surface 230a of the piezoelectric element 230. When the flexure 240 is disposed on the outer surface 61b of the plate 61, the connection tab 241 may be connected to the outer surface 230b of the piezoelectric element 230.

For example, the controller of the PCB 17 applies a voltage to the piezoelectric elements 230 via the FPC 37 and the flexure 240. The two piezoelectric elements 230 individually expand and contract in substantially the Y direction according to the applied voltage.

By individually expanding and contracting, the two piezoelectric elements 230 push or pull the front parts 212 and 222 of the plate 210 and the base tab 220. In this manner, the piezoelectric elements 230 bend the intermediate parts 213 and 223 of the plate 210 and the base tab 220 to adjust the position of the magnetic head 51 in substantially the circumferential direction.

As illustrated in FIG. 8, at least a part of the piezoelectric element 230 is farther away from the corresponding magnetic disk 12 than from the outer surface 61b of the plate 210. In addition, the second part 82 of the flexure 240 is disposed on the inner surface 56a of the base tab 220.

In the HDD 10 of the second embodiment described above, the piezoelectric element 230 is attached to at least one of the base plate 55 and the load beam 56, and is configured to expand and contract so as to bend the base plate 55. At least a part of the piezoelectric element 230 is located farther away from the magnetic disk 12 than the outer surface 61b. With this configuration, the HDD 10 allows a longer distance between the piezoelectric element 230 and the magnetic disk 12 than that between the piezoelectric element 230 attached to the outer surface 61b and the magnetic disk 12, leading to reducing or preventing occurrence of interference between the piezoelectric element 230 and the magnetic disk 12.

The piezoelectric element 230 includes the outer surface 230b configured to face the magnetic disk 12 when the magnetic head 51 is located on the magnetic disk 12; and the inner surface 230a opposite the outer surface 230b and connected to the flexure 240. Thus, a part (connection tab 241) of the flexure 240 is more spaced from the magnetic disk 12 than the piezoelectric element 230. Due to such arrangement, the HDD 10 allows a longer the distance between the flexure 240 and the magnetic disk 12.

In the above description, “suppress” is defined as, for example, preventing an occurrence of an event, an action, or an influence, or decreasing the degree of the event, the action, or the influence. Furthermore, in the above description, “restrict” is defined as, for example, preventing movement or rotation, or allowing movement or rotation within a predetermined range and preventing movement or rotation beyond the predetermined range.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk device comprising:
a magnetic disk configured to rotate about a first rotation axis;
a suspension including a base plate, a load beam attached to the base plate, and a flexure attached to the load beam;
a magnetic head attached to the flexure and configured to read and write information from and to the magnetic disk; and
a carriage including an arm to which the base plate is attached, the carriage configured to rotate about a second rotation axis located apart from the first rotation axis to move the magnetic head with respect to the magnetic disk,
wherein the base plate includes:
a first surface configured to face the magnetic disk when the magnetic head is located on the magnetic disk; and
a second surface being opposite the first surface, facing the arm, and on which a component different from the arm is disposed.

2. The disk device according to claim 1,
wherein the component includes at least either of the load beam and the flexure.

3. The disk device according to claim 1,
wherein the component includes the flexure.

4. The disk device according to claim 3,
wherein the load beam includes:
a third surface configured to face the magnetic disk when the magnetic head is located on the magnetic disk; and
a fourth surface being opposite the third surface,
the load beam is provided with a hole open to the third surface and the fourth surface, and
the flexure includes:
a first part attached to the third surface and on which the magnetic head is mounted;
a second part disposed on the second surface; and
a third part extending between the first part and the second part through the hole.

5. The disk device according to claim 4,
wherein the arm includes:
a fifth surface facing the second surface; and
a sixth surface being opposite the fifth surface,
the arm is provided with a slit between the fifth surface and the sixth surface in a direction in which the fifth surface faces, and
the flexure includes a fourth part extending from the second part to be accommodated in the slit.

6. The disk device according to claim 5,
wherein a part of the fourth part is located outside the slit between the second part and the slit,
the part is more spaced from the first rotation axis than the base plate, and
the part is more spaced from the magnetic disk than the base plate in the direction in which the fifth surface faces.

7. The disk device according to claim 5,
wherein the arm is provided with a recess open to the fifth surface, and
the flexure includes an attachment part accommodated in the recess and attached to the arm.

8. The disk device according to claim 2,
wherein the component includes the load beam.

9. The disk device according to claim 3, further comprising:
a piezoelectric element attached to at least one of the base plate and the load beam and configured to expand and contract to bend the base plate,
wherein at least a part of the piezoelectric element is more spaced from the magnetic disk than the first surface.

10. The disk device according to claim 9,
wherein the piezoelectric element includes:
a seventh surface configured to face the magnetic disk when the magnetic head is located on the magnetic disk; and
an eighth surface being opposite the seventh surface and connected to the flexure.

11. The disk device according to claim 1, wherein the magnetic disk includes eleven or more magnetic disks.

12. The disk device according to claim 1,
wherein the magnetic disk has a thickness of 0.3 mm or more and 0.5 mm or less.
